(19) United States
(12) Patent Application Publication
(10) Pub. No.: US 2013/0104068 A1
(43) Pub. Date: Apr. 25, 2013

(54) TEXT PREDICTION KEY

(71) Applicants: John B. Murphy, Athlone (IE); Moneta Ho Kushner, Bellevue, WA (US); Vasudha Chandrasekaran, Mountain View, WA (US); Seung M. Yang, Woodinville, WA (US); Finbarr S. Duggan, Dublin (IE); Gary J. Sherman, Dublin (IE); Gerrit H. Hofmeester, Woodinville, WA (US)

(72) Inventors: John B. Murphy, Athlone (IE); Moneta Ho Kushner, Bellevue, WA (US); Vasudha Chandrasekaran, Mountain View, WA (US); Seung M. Yang, Woodinville, WA (US); Finbarr S. Duggan, Dublin (IE); Gary J. Sherman, Dublin (IE); Gerrit H. Hofmeester, Woodinville, WA (US)

(73) Assignee: Microsoft Corporation, Redmond, WA (US)

(21) Appl. No.: 13/277,636

(22) Filed: Oct. 20, 2011

(51) Int. Cl. G06F 3/048

(52) U.S. Cl. 715/773

(57) ABSTRACT

A dedicated text prediction key for inserting a text prediction candidate is described. The text prediction key may be configured and/or output for display in conjunction with an on-screen/adaptable keyboard when a prediction for entered characters is detected. The text prediction key provides a mechanism for explicit insertion of a text prediction candidate that can be employed to avoid passive/non-explicit insertions. In at least some embodiments, the text prediction key may be selectively displayed by replacing/modifying one or more keys of the on-screen keyboard. In another approach, the text prediction key may appear at a designated location within or proximate to the on-screen keyboard. The text prediction key may also be configured in various ways to notify a user that a prediction candidate is available.

### BACKGROUND

Computing devices, such as mobile phones, portable and tablet computers, entertainment devices, handheld navigation devices, and the like are commonly implemented with on-screen keyboards (e.g., soft keyboards) that may be employed for text input and/or other interaction with the computing devices. When a user inputs text characters into a text box or otherwise inputs text using an on-screen keyboard or similar input device, a computing device may apply auto-correction to automatically correct misspellings and/or text prediction to predict and offer candidate words/phrases based on input characters.

In a traditional approach, auto-corrections and text predictions are inserted automatically responsive to passive actions such as when a word break is detected. Such passive insertion approaches may be problematic because often words that a user did not intend to type may be inserted automatically through auto correction and text prediction. At the very least users may be frustrated by having to correct/retype inserted text and even worse users not close paying attention to the inserted text may inadvertently send out messages with unintended meanings.

### SUMMARY

A text prediction key is described. In one or more embodiments, a dedicated key for inserting a text prediction candidate is output for display in conjunction with an on-screen keyboard associated with a computing device. The text prediction key provides a mechanism for explicit insertion of a text prediction candidate that can be employed to avoid passive/non-explicit insertions. In at least some embodiments, the text prediction key may be configured for display in conjunction with the on-screen keyboard when availability of a prediction for entered characters is detected. The text prediction key may be selectively presented by replacing/modifying one or more keys of the on-screen keyboard to accommodate the text prediction key. In another approach, the text prediction key may appear at a designated location within or proximate to the on-screen keyboard. The text prediction key may further be configured in various ways to notify a user that a prediction candidate is available and/or present a corresponding prediction text.

### BRIEF DESCRIPTION OF THE DRAWINGS

Embodiments of a text prediction key are described with reference to the following Figures. The same numbers may be used throughout to reference like features and components that are shown in the Figures:

FIG. 1 illustrates an example operating environment in which embodiments of a text prediction key can be implemented.

FIG. 2 illustrates an example text prediction key in accordance with one or more embodiments.

FIG. 3 illustrates an example transition of an on-screen keyboard to present a text prediction key in accordance with one or more embodiments.

FIG. 4 illustrates another example text prediction key in accordance with one or more embodiments.

FIG. 5 illustrates another example text prediction key in accordance with one or more embodiments.

FIG. 6 illustrates example procedures(s) for providing a text prediction key in accordance with one or more embodiments.

FIG. 7 illustrates various components of an example device that can implement embodiments of a text prediction key.

### DETAILED DESCRIPTION

Overview

In traditional approaches, auto-corrections and text predictions are inserted automatically responsive to passive actions such as when a word break is detected. Such passive insertion approaches may be problematic because unintended words may be inserted automatically. This may cause frustration and worse for users who spend time changing text inserted incorrectly and/or inadvertently send out messages with unintended meanings.

Techniques related to a text prediction key are described herein. In one or more embodiments, a dedicated key for inserting a text prediction candidate is configured and output for display in conjunction with an on-screen keyboard. The text prediction key provides a mechanism for explicit insertion of a text prediction candidate that can be employed to avoid passive/non-explicit insertions. In at least some embodiments, the text prediction key may be configured for display in conjunction with the on-screen keyboard when a prediction for entered characters is detected. The text prediction key may be selectively displayed by replacing/modifying one or more keys of the on-screen keyboard to accommodate the text prediction key. In another approach, the text prediction key may appear at a designated location within or proximate to the on-screen keyboard. The text prediction key also may be configured in various ways to notify a user that a prediction candidate is available and/or present corresponding prediction text.

In the discussion that follows, a section titled “Operating Environment” describes but one environment in which the various embodiments can be employed. Following this, a section titled “Text Prediction Key Examples” describes example user interfaces and text prediction keys in accordance with one or more embodiments. Next, a section titled “Text Prediction Key Procedures” describes example procedures in accordance with one or more embodiments. Last, a section titled “Example System” is provided and describes an example system that can be used to implement one or more embodiments.

Operating Environment

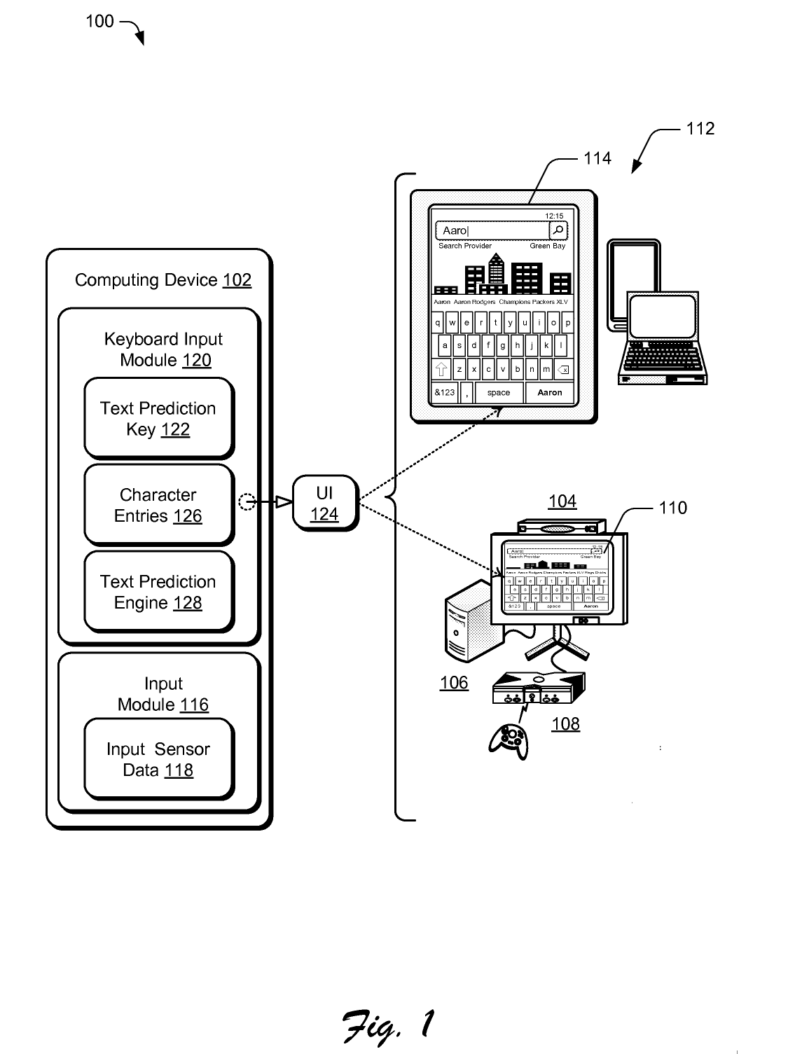

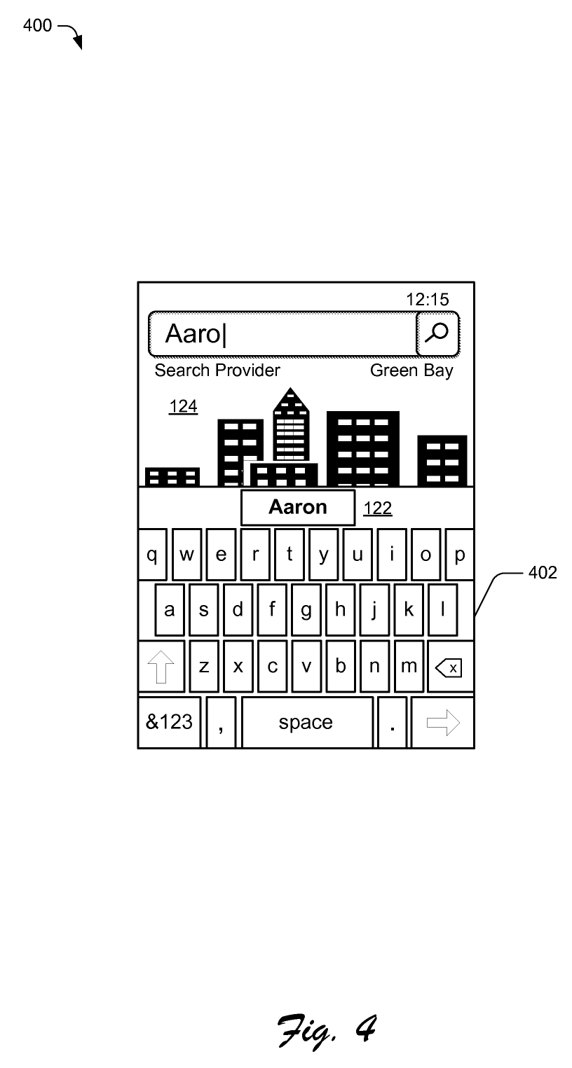

FIG. 1 illustrates an example system 100 in which embodiments of a text prediction key can be implemented. The example system 100 includes a computing device 102, which may be any one or combination of a fixed or mobile device, in any form of a consumer, computer, portable, communication, navigation, media playback, entertainment, gaming, tablet, and/or electronic device. For example, the computing device 102 can be implemented as a television client device 104, a computer 106, and/or a gaming system 108 that is connected to a display device 110 to display media content. Alternatively, the computing device may be any type of portable computer, mobile phone, or portable device 112 that includes an integrated display 114. Any of the computing devices can be implemented with various components, such as one or more processors and memory devices, as well as with any combination of differing components as further described with reference to the example device shown in FIG. 4.

The integrated display 114 of a computing device 102, or the display device 110, may be a touch-screen display that is implemented to sense touch and gesture inputs, such as a user-initiated character, key, typed, or selector input in a user interface that is displayed on the touch-screen display. Alternatively or in addition, the examples of computing devices may include other various input mechanisms and devices, such as a keyboard, mouse, on-screen keyboard, remote control device, game controller, or any other type of user-initiated and/or user-selectable input device.

In implementations, the computing device 102 may include an input module 116 that detects and/or recognizes input sensor data 118 related to various different kinds of inputs such as on-screen keyboard character inputs, touch input and gestures, camera-based gestures, controller inputs, and other user-selected inputs. The input module 116 is representative of functionality to identify touch input and/or gestures and cause operations to be performed that correspond to the touch input and/or gestures. The input module 116, for instance, may be configured to recognize a gesture detected through interaction with a touch-screen display (e.g., using touchscreen functionality) by a user's hand. In addition or alternatively, the input module 116 may configured to recognize a gesture detected by a camera, such as waving of the user's hand, a grasping gesture, an arm position, or other defined gesture. Thus, touch inputs, gestures, and other input may also be recognized through input sensor data 118 as including attributes (e.g., movement, selection point, positions, velocity, orientation, and so on) that are usable to differentiate between different inputs recognized by the input module 116. This differentiation may then serve as a basis to identify a gesture from the inputs and consequently an operation that is to be performed based on identification of the gesture.

The computing device includes a keyboard input module 120 that can be implemented as computer-executable instructions, such as a software application or module that is executed by one or more processors to implement the various embodiments described herein. The keyboard input module 120 represent functionality to provide and manage an on-screen keyboard for keyboard interactions with the computing device 102. The keyboard input module 120 may be configured to cause representations of an on-screen keyboard to be selectively presented at different times, such as when a text input box, search control, or other text input control is activated. An on-screen keyboard may be provided for display on an external display, such as the display device 110 or on an integrated display such as the integrated display 114. In addition, note that a hardware keyboard/input device may also implement an adaptable “on-screen” keyboard having at least some soft keys suitable for the techniques described herein. For instance, a hardware keyboard provided as an external device or integrated with the computing device 102 may incorporate a display device, touch keys, and/or a touchscreen that may be employed to display a text prediction key as described herein. In this case, the keyboard input module 120 may be provided as a component of a device driver for the hardware keyboard/input device.

The keyboard input module 120 may include or otherwise make use of a text prediction key 122 that may be selectively represented within a user interface 124 output by the computing device for display on the integrated display 114 of a computing device 102, or for display on the display device 110. More particularly, the text prediction key 122 may be configured as a dedicated key that may be provided for inserting a text prediction candidate presented in conjunction with an on-screen keyboard implemented by the keyboard input module 120. As mentioned, the on-screen keyboard may be selectively exposed to facilitate keyboard interaction in various text input scenarios. For example, an on-screen keyboard may be selectively exposed for input of text in a text entry box, password entry box, search control, data form or other text input controls of a user interface 124, such as a form, HTML page, or document to facilitate user input of character entries 126 (e.g., letters, numbers, and/or other alphanumeric characters).

The keyboard input module 120 may include or otherwise make use of a text prediction engine 128 that represents functionality to process and interpret character entries 126 to form and offer predictions of candidate words corresponding to the character entries 126. In general, the text prediction engine 128 ascertains one or more possible candidates that most closely match character entries 126 that are input. In this way, the text prediction engine 128 can facilitate text entry by providing one or more predictive words that are ascertained in response to character entries 126 that are input by a user.

In accordance with techniques described herein, a text prediction key 122 may be configured and/or output by the keyboard input module 120 whenever the text prediction engine 128 offers a prediction. The prediction text associated with a prediction may then be inserted into an appropriate text input control by explicit selection of the text prediction key 122. Moreover, in at least some embodiments, passive/non-explicit insertion of prediction text is disabled to avoid inadvertent/automatic insertions of unintended words. Thus, users may rely upon the dedicated text prediction key 122 to explicitly select an available prediction without having to worry about predictions being automatically inserted.

Having considered an example environment, consider now a discussion of some text prediction key examples that further illustrate various aspects.

Text Prediction Key Examples

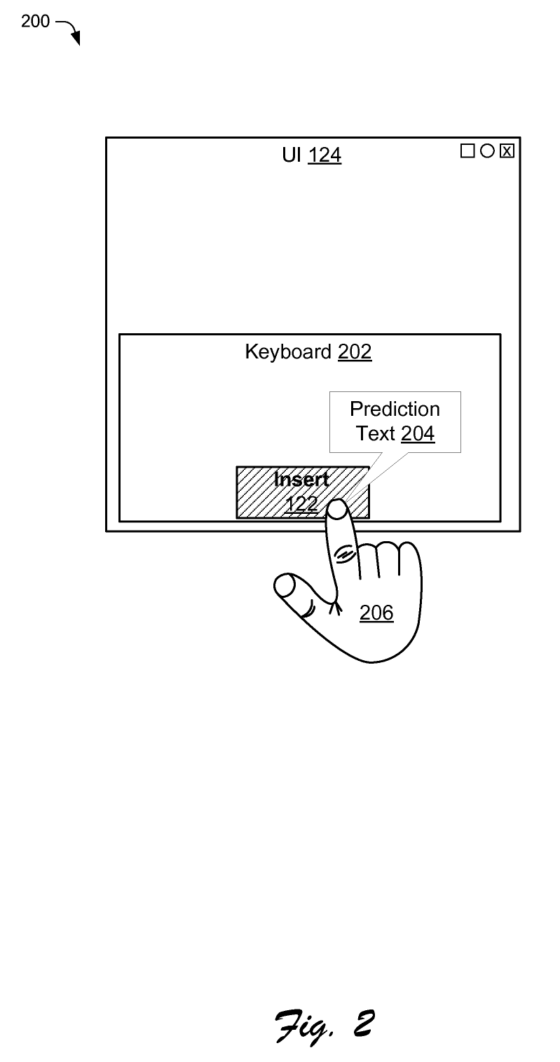

FIG. 2 illustrates a text prediction key example in accordance with one or more embodiments, generally at 200. The example text prediction key can be implemented by the computing device 102 and the various components described with reference to FIG. 1. In particular, FIG. 2 depicts an example user interface 124 that may be output to facilitate interaction with a computing device 102. The user interface 124 is representative of any suitable interface that may be provided for the computing device, such as by an operating system or other application program. As depicted, the user interface 124 may include or otherwise be configured to make use of a keyboard 202. In this example, the keyboard 202 is an on-screen keyboard that may be rendered and/or output for display on a suitable display device. In some cases, the keyboard 202 may be incorporated as part of an application and appear within a corresponding user interface 124 to facilitate text entry, navigation, and other interaction with the application. In addition or alternatively, a representation of a keyboard 202 may be selectively exposed by a keyboard input module within a user interface 124 when text entry is appropriate. For example, the keyboard 202 may selectively appear when a user activates a text input control such as a search control, data form, or text input box. As mentioned, a suitably configured hardware keyboard may also be employed to provide a representation of a text prediction key as described herein.

The example keyboard 202 further includes a text prediction key 122, which in this example is labeled as an “insert” button. A text prediction key 122 may be configured in various ways. In general, the text prediction key 122 may be accommodated within the key layout of the keyboard 202. This may occur by providing the text prediction key 122 at a designated location within an arrangement of keys for the keyboard 202.

In at least some embodiments, a keyboard input module 120 may cause the text prediction key 122 to appear selectively when a suitable text prediction candidate is available from the text prediction engine 128. In this approach, the key layout may transition between different states to add the text prediction key 122 when appropriate. This may involve replacing, rearranging, and/or modifying one or more keys of the keyboard to provide the text prediction key 122 at a designated location. Thus, a default state of the keyboard 202 may appear at times when a text prediction candidate is unavailable. Then, when a text prediction candidate becomes available, the keyboard 202 may transition to a prediction state in which the text prediction key 122 appears. For example, the text prediction key 122 may be inserted to replace one or more default keys of an on screen keyboard. In another example, a designated key, such as the space bar, may be split and/or shrunk down in size to provide a location for the text prediction key 122. Still further, one or more keys may be moved and/or resized to accommodate insertion of a text prediction key 122 at a designated location associated with the keyboard. These and other examples are discussed in greater detail in relation to the following figures.

In another approach, a dedicated text prediction key 122 may be incorporated as a key in the default state of the keyboard 202. For example, the text prediction key 122 may be positioned at a designated location and may appear whenever the keyboard 202 is displayed. The text prediction key 122 may be provided statically as a component of the keyboard 202. Accordingly, the dedicated text prediction key 122 may appear as part of the keyboard 202 both when prediction candidates are available and unavailable. In other words, the text prediction key 122 can be provided as a standard/default key rather than being selectively exposed as discussed above. In this approach, the text prediction key 122 may appear but be disabled/inactive when a prediction candidate is unavailable. When prediction candidate is available, the text prediction key 122 may become enabled/active and may be employed in various ways described above and below.

Disabling and enabling a displayed text prediction key 122 may be accomplished in various ways. For example, the text prediction key 122 may be transitioned between locked and unlocked states in a way that prevents the key from operating in a locked state. A corresponding visual change to the appearance of the key may also occur such as by changing coloring of the text prediction key 122 in the different states, “graying-out” the key when it is disabled, and other suitable ways of visually indicating when the text prediction key 122 and/or predictions are available/unavailable. In general, such visual changes are configured to cause the text prediction key 122 to become visually more prominent when a text prediction is available and/or less prominent at other times when text predictions are unavailable.

A text prediction key 122 may also be configured to notify a user of available text predictions in various ways. For example, the text prediction key 122 may be configured to visually notify a user with colors, color changes, flashing, blinking and other visual clues applied to the text prediction key 122. An audible alert may also be provided in connection with the text prediction key 122 when a prediction candidate is available. Additionally, the text prediction key 122 may also be configured to display or enable selective access to the prediction text 204 for a prediction.

For example, rather than being labeled “insert” the text prediction key 122 may be labeled with prediction text 204 corresponding to a prediction candidate. In another example, prediction text 204 may selectively appear when a user interacts with the text prediction key 122 in a designated way to trigger display of one or more prediction candidates. For example, FIG. 2 depicts a balloon having prediction text 204 as appearing when a finger of a user's hand 206 hovers at or near the text prediction key 122. Alternative, prediction text 204 associated with a prediction may appear near the text input control/text caret, such as in a pop-up box or otherwise.

More generally, any suitable triggering action may cause prediction text 204 to appear using an appropriate user interface instrumentality, such as the illustrated balloon, a drop-down box, a slide-out element, a pop-up box, toast message window, or a list box to name a few examples. The prediction text 204 may be shown at one or more different locations including but not limited to being shown with or proximate to a text input control and/or with or proximate to a text prediction key 122, using various user interface instrumentalities. Operation of the text prediction key 122 causes associated prediction text to be inserted as text input into a corresponding text input control.

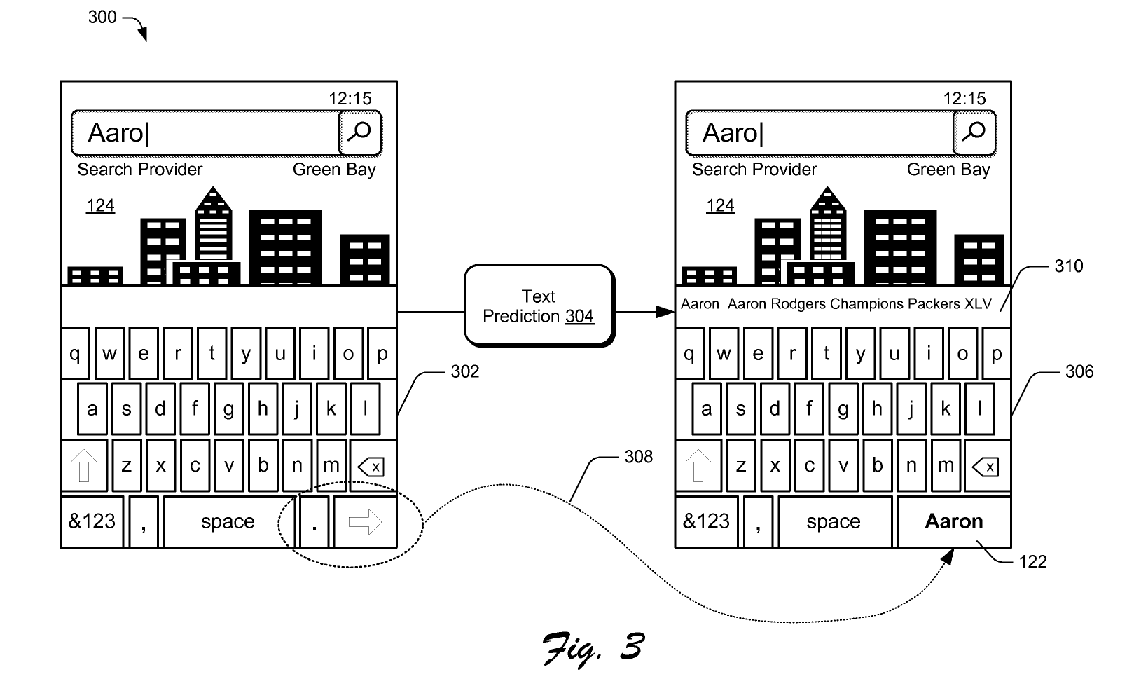

Multiple different available prediction options from which a user may select may also be provided and displayed in a comparable manner. For example, multiple predictions from which a user may select may be displayed on or adjacent to a text prediction key 122 as labels, in a list box, in a slide-out element or using other user interface instrumentalities associated with the text prediction key 122. The user may then interact with a finger press or designated gesture (e.g., a finger slide or grasping gesture) to select one of the displayed candidates. In addition, multiple keys may be converted to multiple text prediction keys 122 to represent the different available predictions candidates. A user may then select one of the keys to insert a corresponding prediction. Some additional examples of different kinds of text prediction keys that may be employed are described just below with reference to FIGS. 3-5.

FIG. 3 illustrates an example transition between states for an on-screen keyboard to present a text prediction key in accordance with one or more embodiments, generally at 300. In this example, a user interface 124 configured for interaction with a search provider is depicted having an on-screen keyboard in a default state a 302. The interface includes a text input control in the form of a search input box. A user has interacted with the text input control to input the text characters “Aaro”. In response to input of this text, the text prediction engine 128 may operate to determine one or more prediction candidates. When this text prediction 304 occurs, the keyboard input module 120 may detect that one or more prediction candidates are available and cause a corresponding text prediction key 122 to appear by modifying and/or rearranging the keyboard and/or one or more keys of the keyboard. In particular, the keyboard input module 120 may cause the keyboard to transition from the default state 302 to a prediction state 306 having a text prediction key 122 as shown in FIG. 3.

In the depicted example, the text prediction key 122 is inserted by replacing two default keys of the on-screen keyboard (e.g., the period key and right arrow key) as represented by the arrow 308. A variety of other modifications and/or rearrangements of a keyboard to provide a text prediction key are also contemplated. Naturally, a text prediction key 122 may be inserted at different locations and may replace different keys than those shown by way of example in FIG. 3. Moreover, various keys of the keyboard may be moved, resized, rearranged, and/or otherwise modified to accommodate a text prediction key 122 at any designated location for the key. This may include providing a dedicated location and displaying the text prediction key 122 in the default state 302 as well as selectively showing the text prediction key 122 in different states as in the depicted example.

If appropriate, a visual transition between the different states for the keyboard may also be shown in any suitable way. The transition may include selectively showing/hiding different keys, modifying colors, sizes, and other properties of keys, animating rearrangement and movement of keys, and so forth. Notice, that in this example, the text prediction key 122 is labeled with prediction text “Aaron”, which serves to present the text to a user as well as provide notification that the prediction is available. Other types of notifications and techniques to present prediction text as described previously may also be employed. In addition, the text prediction key 122 may optionally be used in combination with other auto-correct/text prediction techniques. By way of example and not limitation, in FIG. 3 various text prediction options are shown in a text prediction bar 310 that appears at the top of the keyboard in addition to inserting the text prediction key 122. In this scenario, the text prediction key 122 may be operable to cause insertion of a default candidate from the text prediction bar 310 that has the focus in addition to inserting a candidate through interaction with the text prediction bar 310. Of course, the text prediction key 122 may also be configured as an exclusive mechanism for selection of text predictions in some scenarios.

FIG. 4 illustrates another example text prediction key in accordance with one or more embodiments, generally at 400. In this example, another example keyboard arrangement 402 for a user interface 124 is depicted. Here, a text prediction key 122 is illustrated a being provided at a dedicated location in the keyboard arrangement 402. In this case, the text prediction key 122 may appear at a dedicated location without replacing, rearranging, or otherwise modifying other keys. For instance, the text prediction key 122 of FIG. 4 is depicted as appearing generally at the center of the display at the top of the keyboard. As in the previous example, the text prediction key 122 is labeled with prediction text “Aaron”. Thus, selection of the text prediction key 122 may cause the text “Aaron” to be input into the corresponding search input box of FIG. 4.

In one approach, the example text prediction key 122 of FIG. 4 may be provided in the default state for the keyboard. In this case, text prediction key 122 may appear by default whenever the keyboard is presented. The prediction text and/or other clues (e.g., color change, blinking, etc.) may appear selectively when a prediction is available to notify a user. The prediction text used to label the key may also change as text is input to reflect different predictions that may be made as different text characters are input. In addition or alternatively, a transition from the default state 302 of FIG. 3 to the arrangement shown in FIG. 4 may occur to selectively show the text prediction key 122 when a prediction candidate is available in a manner comparable to the transition described in relation to FIG. 3.

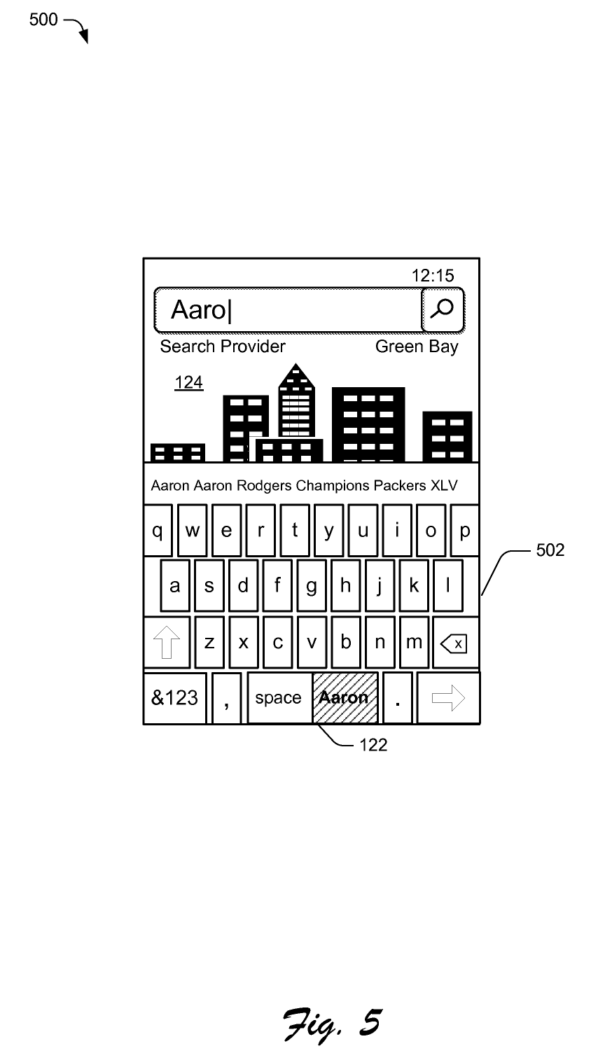

FIG. 5 illustrates another example text prediction key in accordance with one or more embodiments, generally at 500. In this example, another example keyboard arrangement 502 for a user interface 124 is depicted. Here, a text prediction key 122 is illustrated a being provided by modifying/rearranging another key to accommodate the text prediction key 122. In particular, the footprint of the space bar shown in the default state 302 of FIG. 3 is split in two and the space bar is shrunk down in size to accommodate placement of the text prediction key 122 within the footprint occupied by the space bar in the default state. The text prediction key 122 is inserted to occupy approximately half of the original footprint of the space bar. The text prediction key 122 shows corresponding prediction text “Aaron” and may also be colored/highlighted to provide notice that the prediction is available. The keyboard arrangement 502 may be presented by transitioning from the default state 302 in the manner previously described when a prediction candidate is determined by the text prediction engine 128. In addition or alternatively, the example keyboard arrangement 502 may also be provided as the default state 302 and/or may be selectively set as the default arrangement for the keyboard. In this case, text prediction key 122 is provided by default whenever the keyboard is presented and transitions to make the key visually more prominent may occur when a prediction is available as described above and below.

In addition or alternatively to providing a dedicated key operable to insert the text prediction candidate as in the forgoing examples, a gesture may be defined to facilitate insertion of a text prediction candidate. For instance, a prediction candidate may be exposed in connection with a designated key as a label or otherwise when an appropriate prediction candidate is available using the techniques described above and below. The default functionality of the designated key may be maintained, such that the key operates in a “normal” way when tapped, clicked, or otherwise selected. In addition, a particular gesture in relation to the key may be defined to cause insertion of the corresponding prediction candidate. For instance, a finger slide across the key, a circular gesture around the key, a double tap, or any suitable gesture may be employed to insert the corresponding candidate. By way of example, the spacebar may be configured to selectively display prediction candidates as the candidates become available. In this example, tapping on the spacebar causes insertion of a space, but a designated gesture, such as horizontally sliding of a user's finger over the spacebar (or another defined gesture), may be employed to cause insertion of the prediction candidate. In this way, a default key can be associated with a gesture such that the key can be configured as a dedicated prediction key that has dual functionally for text predictions and “normal” operation of the key (e.g., character insertion).

Having described some example text prediction keys, consider now a discussion of example procedures to provide a text prediction keys in accordance with one more embodiments.

Text Prediction Key Procedures

The following discussion describes techniques for text prediction keys that may be implemented utilizing the previously described systems and devices. Aspects of each of the described procedure(s) may be implemented in hardware, firmware, or software, or a combination thereof. The procedure(s) are shown as a set of blocks that specify operations performed by one or more devices and are not necessarily limited to the orders shown for performing the operations by the respective blocks. In at least some embodiments, the procedure(s) may be performed by a suitably configured computing device, such as the example computing device 102 of FIG. 1 that includes or otherwise makes use of a keyboard input module 120.

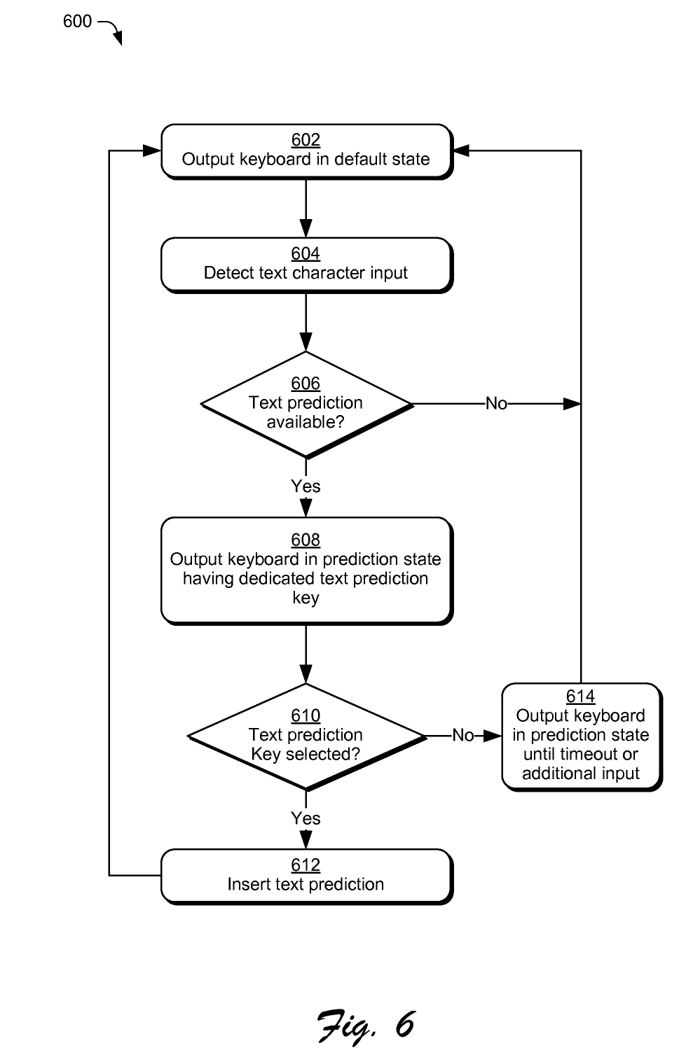

FIG. 6 depicts a procedure 600 in an example implementation in which a text prediction key is provided in accordance with one or more embodiments. A keyboard is output in a default state (block 602). For example, a user interface 124 as previously described may be output by various applications of a computing device 102. A keyboard input module 120 may operate to provide an on-screen keyboard for display via the user interface at appropriate times, such as when a text input control of some type is activated. In the default state, the on-screen keyboard may be provided in a first arrangement. In accordance with the preceding examples of FIGS. 2-5, the keyboard in the first arrangement may or may not initially include a text prediction key 122. In either case, the keyboard may be transitioned to a second arrangement when a text prediction candidate is available by replacing, rearranging, relocating, resizing and/or otherwise modifying one or more keys of the keyboard. The transition may cause a text prediction key 122 to selectively appear in the keyboard and/or to be selectively activated and made visually more prominent to provide notice of the available text prediction.

Accordingly, the keyboard input module 120 may operate to determine when predictions are available, obtain predictions to configure a text input key, and/or initiate transition of a keyboard between different states as appropriate. In particular, text character input is detected (block 604) and a determination is made regarding whether a text prediction is available (block 606). Here, the keyboard input module 120 may monitor text input controls to determine when various character entries 126 are input. The keyboard input module 120 may further include or otherwise make use of a text prediction engine 128 to make predictions based on the character entries 126. Through interaction with the text prediction engine 128, the keyboard input module 120 can ascertain when predictions are available and unavailable for a given text input scenario. The keyboard input module 120 may also obtain the text predictions from the text prediction engine 128 to configure a corresponding text prediction key. At times when a prediction is not available, the keyboard input module 120 may continue to cause presentation of the keyboard in the first arrangement (e.g., default state) and may continue to monitor for text input and/or corresponding predictions by the text prediction engine 128.

When a prediction is available, though, the keyboard is output in a prediction state having a dedicated text prediction key (block 608). Here, the keyboard input module 120 may cause a transition of the keyboard from the first arrangement of the default state to a second arrangement in a prediction state. For instance, a transition comparable to the examples shown and described in relation to FIGS. 3-5 may occur when a prediction is available. In cases in which a text prediction key 122 does not appear in the default state, the transition may cause the text prediction key 122 to selectively appear at a designated location by replacing keys or otherwise modifying the first arrangement of the keyboard to produce the second arrangement having the dedicated text prediction key. In cases in which a text prediction key 122 is provided in the default state, the transition may cause the text prediction key 122 to selectively switch from being disabled/inactive to enabled/active. As mentioned previously, this may include causing the text prediction key 122 to become visually more prominent such as by changing colors, animations, adding prediction text, or using other suitable techniques.

In the prediction state, a determination is made regarding whether the text prediction key is selected (block 610). When the text prediction key is selected, the text prediction made available for the input characters is inserted (block 612). For instance, the keyboard input module 120 may detect selection of the text prediction key. In response, the keyboard input module 120 may cause insertion of prediction text associated with the text prediction key into a corresponding text input control. Here, the text prediction may be inserted and replace the initial character(s) and/or word(s) which caused that text prediction to be generated. This may be accomplished in any suitable way including by overwriting the initial characters and/or by appending additional characters to the initial characters to produce the corrected text. For example, selection of the example prediction keys shown in FIGS. 3-5 results in insertion of “Aaron” into the example search input control to replace “Aaro”. After insertion of the prediction, the keyboard may transition back to the first arrangement of the default state and the described procedure may be repeated for additional input text characters.

When the text prediction key is not selected in block 610, the keyboard is output in the prediction state until a timeout occurs or additional characters are input (block 614). Accordingly, the prediction state may be maintained for a designated period of time (e.g., a timeout) after which the keyboard “times out” and may revert to the default state. The keyboard may also transition back to the default state if additional characters are input, which effectively indicates that the user ignored or otherwise did not act upon the prediction. The described procedure 600 may then be repeated for additional input text characters.

In addition or alternatively, a transition to show a text prediction key for additional input text and another prediction may be made without first reverting back to the default state. This may depend upon the timing between different predictions. For instance, the label displayed on a text prediction key 122 may change successively to different prediction text as characters are being input to reflect different respective predictions that are made in relatively quick succession. Effectively, the text prediction key 122 remains visible at a designated location and adjusts for the different successive predictions in this scenario.

Having described some example techniques related to text prediction keys, consider now an example device that can be utilized to implement one more embodiments described above.

Example Device

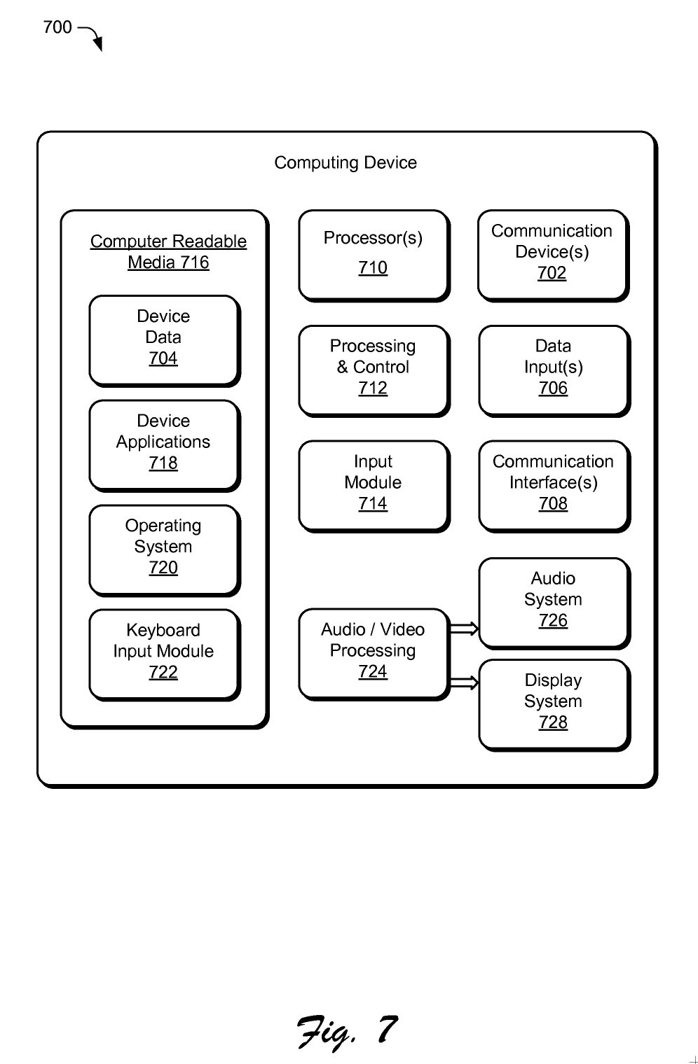

FIG. 7 illustrates various components of an example device 700 that can be implemented as any type of computing device as described with reference to the previous figures to implement embodiments of a text prediction key described herein. In embodiments, the device may be implemented as any one or combination of a fixed or mobile device, in any form of a consumer, computer, portable, user, communication, phone, navigation, television, appliance, gaming, media playback, and/or electronic device. The device may also be associated with a user (i.e., a person) and/or an entity that operates the device such that a device describes logical devices that include users, software, firmware, hardware, and/or a combination of devices.

The device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable or readable instructions to control the operation of device 700 and to implement the gesture embodiments described above. Alternatively or in addition, device 700 can be implemented with any one or combination of hardware, firmware, or fixed logic circuitry that is implemented in connection with processing and control circuits which are generally identified at 712. In embodiments, the device 700 can also include an input module 714. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 716 that may be configured to maintain instructions that cause the device, and more particularly hardware of the device to perform operations. Thus, the instructions function to configure the hardware to perform the operations and in this way result in transformation of the hardware to perform functions. The instructions may be provided by the computer-readable media to a computing device through a variety of different configurations.

One such configuration of a computer-readable media is signal bearing media and thus is configured to transmit the instructions (e.g., as a carrier wave) to the hardware of the computing device, such as via a network. The computer-readable media may also be configured as computer-readable storage media that is not a signal bearing medium and therefore does not include signals per se. Computer-readable storage media for the device 700 can include one or more memory devices/components, examples of which include fixed logic hardware devices, random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device.

Computer-readable media 716 provides data storage mechanisms to store the device data 704, as well as various device applications 718 and any other types of information and/or data related to operational aspects of device 700. For example, an operating system 720 can be maintained as a computer application with the computer-readable media 716 and executed on processors 710. The device applications 718 can include a device manager (e.g., a control application, software application, signal processing and control module, code that is native to a particular device, a hardware abstraction layer for a particular device, etc.). The device applications 718 also include any system components or modules to implement embodiments of the techniques described herein. In this example, the device applications 718 include a keyboard input module 722 that is shown as a software module and/or computer application. The keyboard input module 722 is representative of software that is used to provide an on-screen keyboard and/or a text prediction key(s) 122 as described above and below. Alternatively or in addition, the keyboard input module 722 as well as other device applications 718 and components of the device 700 may be implemented as hardware, fixed logic device, software, firmware, or any combination thereof.

Device 700 also includes an audio and/or video input-output system 724 that provides audio data to an audio system 726 and/or provides video data to a display system 728. The audio system 726 and/or the display system 728 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 726 and/or the display system 728 are implemented as external components to device 700. Alternatively, the audio system 726 and/or the display system 728 are implemented as integrated components of example device 700.

### CONCLUSION

Embodiments of a text prediction key have been described herein. A text prediction key may be selectively displayed in conjunction with an on-screen keyboard when a prediction for entered text characters is available. This may occur by replacing or otherwise modifying one or more keys of the on-screen keyboard to accommodate the text prediction key. The text prediction key may also be configured in various ways to notify a user that a prediction candidate is available and/or present a corresponding prediction.

Although embodiments of a text prediction key have been described in language specific to features and/or methods, the appended claims are not necessarily limited to the specific features or methods described. Rather, the specific features and methods are disclosed as example implementations of a text prediction key.

1. A method, comprising:
detecting a text prediction that is available in connection with input of text characters to a text input control of a user interface for a computing device;
configuring a representation of a keyboard for interaction with the text input control to include a dedicated text prediction key for the detected text prediction; and
outputting the representation of the keyboard having the dedicated text prediction key for display to enable selection of the text prediction key to insert the detected text prediction into the text input control.

2. A method as recited in claim 1, wherein the representation of the keyboard is configured as an on-screen keyboard displayed on a display device for interaction with the computing device.

3. A method as recited in claim 1, wherein the representation of the keyboard is output for display by an adaptable hardware keyboard device configured for interaction with the computing device.

4. A method as recited in claim 1, wherein outputting the representation of the keyboard comprises causing a transition between a default state for the keyboard and a prediction state for the keyboard having the dedicated text prediction key.

5. A method as recited in claim 1, wherein configuring the representation of the keyboard comprises replacing one or more keys included in a default state of the keyboard with the dedicated text prediction key for the detected text prediction.

6. A method as recited in claim 1, wherein the text prediction key is included in a default state of the keyboard and configuring the representation of the keyboard comprises configuring the text prediction key to become visually more prominent in a prediction state of the keyboard.

7. A method as recited in claim 1, wherein configuring the representation of the keyboard comprises rearranging one or more keys of the keyboard in the representation to accommodate the dedicated text prediction key at a designated location within the arrangement of keys for the keyboard.

8. A method as recited in claim 1, further comprising inserting the text prediction into text input control responsive to receiving an explicit selection of the text prediction key.

9. A computing device, comprising:
one or more processors; and
one or more computer-readable media storing instructions that, when executed by the one or more processors, implement a keyboard input module operable to:
output a representation of a keyboard in a default state having a first arrangement of keys to enable input of text characters to a text input control of a user interface;
obtain prediction text that is determined based on characters input into the text input control of the user interface; and
in response to detection of the prediction text, transition the representation of the keyboard between the default state and a prediction state having a second arrangement of keys that includes a dedicated text prediction key selectable to insert the prediction text into the text input control.

10. A computing device as recited in claim 9, wherein the keyboard input module is further operable to:
detect selection of the text prediction key;
in response to detection of the text prediction key, insert the prediction text into the text input control; and
transition the representation of the keyboard back to the default state.

11. A computing device as recited in claim 9, wherein the keyboard input module is further operable to configure the dedicated text prediction key to cause prediction text associated with one or more predictions to appear via a user interface instrumentality associated with the text prediction key responsive to user interaction with the text prediction key.

12. A computing device as recited in claim 9, wherein the keyboard input module is further operable to label the dedicated text prediction key with prediction text associated with one or more predictions as different text characters are input into the text input control.

13. A computing device as recited in claim 9, wherein the keyboard input module is further operable to provide notice that the prediction text is available by applying one or more visual clues to the text prediction key.

14. A computing device as recited in claim 9, wherein the transition includes inserting the dedicated text prediction key to appear at a designated location within the keyboard in the prediction state by modifying one or more keys included as default keys in the default state.

15. A computing device as recited in claim 9, wherein the dedicated text prediction key is included as a default key in the default state and the transition includes applying one or more visual changes to the dedicated text prediction key that cause the dedicated prediction key become visually more prominent in the prediction state and provide notice that the prediction text is available.

16. One or more computer-readable storage media storing instructions that, when executed by a computing device, cause the computing device to perform operations comprising:
ascertaining one or more text prediction candidates based on text characters input into a text input control via an on-screen keyboard output for interaction with the computing device in a default state having a first arrangement of keys; and
rearranging the on-screen keyboard into a prediction state having a second arrangement of keys that includes a dedicated text prediction key corresponding to the one or more determined text prediction candidates by modifying the first arrangement in the default state to produce the prediction state.

17. One or more computer-readable storage media as recited in claim 16, wherein the rearranging comprises replacing one or more keys at a designated location in the first arrangement of the default state with the dedicated text prediction key to cause the dedicated text prediction key to appear within the second arrangement of keys of the prediction state.

18. One or more computer-readable storage media as recited in claim 16, wherein the rearranging comprises splitting a footprint associated with a designated key provided in the first arrangement of the default state, resizing the designated key, and placing both the resized designated key and the text prediction key within the footprint to accommodate the text prediction key within the second arrangement of keys of the prediction state.

19. One or more computer-readable storage media as recited in claim 16, wherein the rearranging comprises exposing the text prediction key in the prediction state at a designated location in the second arrangement of keys without modifying keys included in the first arrangement of keys of the default state.

20. One or more computer-readable storage media as recited in claim 16, wherein:
the text prediction key appears as an inactive key in the first arrangement of keys of the default state; and
the rearranging comprises changing the text prediction key from an inactive key to an active key in the second arrangement of keys of the prediction state including at least causing a visual change to the text prediction key that indicates availability of the one or more text prediction candidates.
